(19) United States
(12) Patent Application Publication
(10) Pub. No.: US 2003/0041315 A1
(43) Pub. Date: Feb. 27, 2003

(54) Debugger with automatic detection of control points influencing program behavior

(75) Inventors: Cary Lee Bates, Rochester, MN (US); William Jon Schmidt, Rochester, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY (US)

(21) Appl. No.: 09/934,407

(22) Filed: Aug. 21, 2001

(51) Int. Cl. G06F 9/44; H02H 3/05

(52) U.S. Cl. 717/129; 714/38

(57) ABSTRACT

A method and apparatus for debugging computer programs that provides means for inserting breakpoints at program logic decision points that may have caused an event to occur. Such an event may be an unexpected halt, the execution of unexpected program statements, or the assignment to a variable of an unexpected value. A Control Flow Graph (CFG) is provided that represents the possible flows through the computer program as a sequence of basic blocks. A Control Dependence Graph (CDG) is provided that maps each basic block in the computer program to those other blocks that may determine whether the first block will be executed. The information in the CFG and CDG is used to determine where the breakpoints should be set.

### BACKGROUND OF THE INVENTION

1. Field of the Invention

The present invention generally relates to computers and computer software. More specifically, the invention is generally related to debugging software.

2. Description of the Related Art

Inherent in any software development technique is the potential for introducing “bugs”. A bug will typically cause unexpected results during the execution of the program. Locating, analyzing, and correcting bugs in a computer program is a process known as “debugging”. Debugging of programs may be either done manually or interactively by a debugging system mediated by a computer system. Manual debugging of a program requires a programmer to manually trace the logic flow of the program and the contents of memory elements, e.g., registers and variables. In the interactive debugging of programs, the program is executed under the control of a monitor program (known as a “debugger”), commonly located on and executed by the same computer system on which the program is executed.

An interactive high-level debugger typically operates at the program statement level, meaning that the program can be stepped through at the level of the source code. A “statement number mapping” is provided by the compiler of the source code to allow the debugger to determine which low-level machine instructions correspond to high-level program statements.

When debugging a program by tracing through program statements, the user often finds that the program has entered an unexpected state. For example, it may be that a variable has taken on an unexpected value, or the program has executed code that should not have been reached. Unless the user has been stepping through the program very slowly and carefully, the chain of events causing the unexpected behavior to occur is not known. In such a case, the user needs to resolve how the program arrived at a particular program statement or how a particular variable took on an unexpected value.

Therefore there is a need for a system and method that automatically identifies decision points in a program and places breakpoints at those decision points.

### SUMMARY OF THE INVENTION

The present invention generally provides an apparatus, program product, and a method for debugging computer programs that addresses the problems associated with determining program flow to an unexpected event in the program.

In one embodiment, a method is provided to place breakpoints at places of interest in a program being debugged. The user identifies a statement of interest, which may be the statement at which the program halted execution. The method then determines which basic block contains the statement and then determines which blocks control execution of the basic block. A breakpoint is then inserted at each branch contained in the blocks that control execution of the basic block.

In another embodiment, a program variable of interest is identified by the user. The method then determines which statement(s) in the program being debugged may modify the variable. The method then determines which basic block contains the statement(s) and then determines which blocks control execution of the basic block. A breakpoint is then inserted at each branch contained in the blocks that control execution of the basic block.

In still another embodiment, the method identifies a plurality of sets of loop latches and loop headers contained in the program being debugged. The method then identifies the statements associated with the loop latches. The method then determines which basic blocks contain the statements and then determines which blocks control execution of the basic blocks. A breakpoint is then inserted at each branch contained in the blocks that control execution of the basic blocks.

In still another embodiment, the method identifies the currently executing statement of a plurality of subprograms contained in the program being debugged. The method then determines which basic block contains the statement(s) and then determines which blocks control execution of the basic block. A breakpoint is then inserted at each branch contained in the blocks that control execution of the basic block.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a computer system consistent with the invention.

FIG. 2 illustrates a Control Flow Graph.

FIG. 3 illustrates a Control Dependence Graph (CFG).

FIG. 4 illustrates a Debug Information File.

FIG. 5 illustrates a flow chart of the method of finding basic block branches of interest.

FIG. 6 illustrates a Statement Mapping Table.

FIG. 7 is a flow chart of the method of finding basic block branches that influence whether a particular variable of interest may be modified.

FIG. 8 illustrates a Variable Definition Information.

FIG. 9 shows a loop nest table.

FIG. 10 shows a loop latch table.

FIG. 11 illustrates a CFG comprising loop latches and loop headers.

FIG. 12 illustrates a method of finding basic block branches of interest for blocks occurring in loops.

FIG. 13 illustrates a method of finding basic block branches of interest for all currently active procedures.

FIG. 14 shows a call stack.

### DETAILED DESCRIPTION OF THE PREFERRED EMBODIMENTS

The present invention generally provides a method, apparatus and article of manufacture for debugging computer programs. In general, debugging computer programs is aided by automatically setting breakpoints at decision points in the computer program. In one embodiment, the program statement number where the program being debugged halted execution is referenced to a basic block in the Control Flow Graph (CFG). The Control Dependence Graph (CDG) is then consulted to determine which basic blocks in the program being debugged control execution of the referenced basic block. Breakpoints are then set at the branch statements in each controlling basic block. In another embodiment, debugging is aided by determining which program statements may have changed the value of a particular variable, identifying the basic blocks that control execution of those statements, and setting breakpoints at the branch statements in each controlling basic block. In still another embodiment, the set of controlling blocks in which breakpoints are set is extended to include blocks that can cause an active loop to iterate. In still another embodiment, the set of controlling blocks in which breakpoints are set is extended to include controlling blocks in all active procedures on the call stack.

The program modules that define the functions of the present embodiments may be placed on a signal-bearing medium. The signal-bearing media include, but are not limited to, (i) information permanently stored on non-writable storage media, (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, object, module or sequence of instructions will be referred to herein as computer programs, or simply programs. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention.

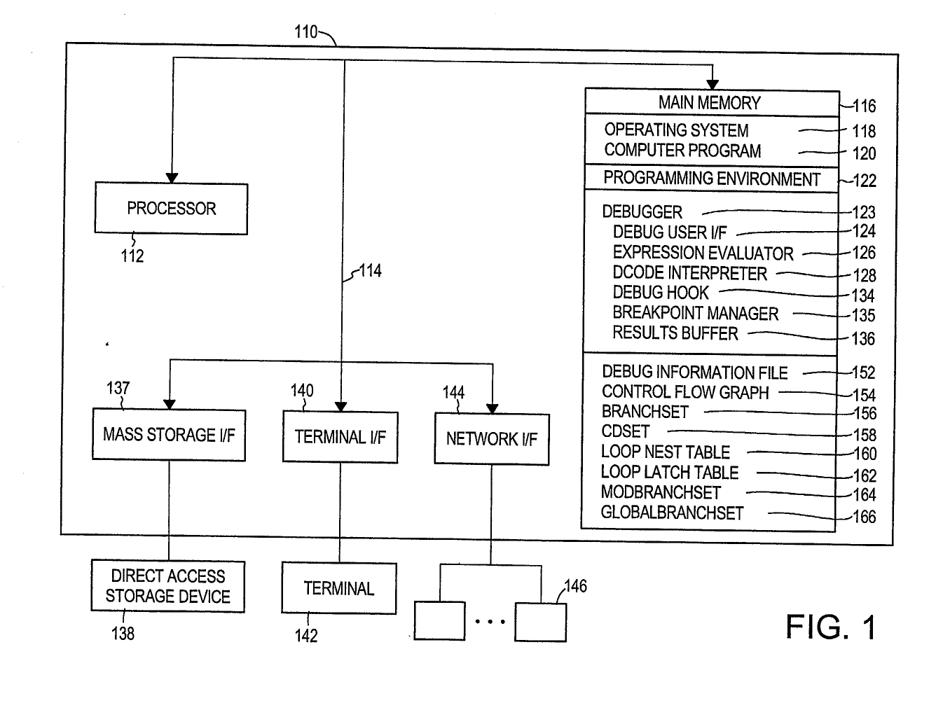

A particular system for implementing the present embodiments is described with reference to FIG. 1. However, those skilled in the art will appreciate that embodiments may be practiced with any variety of computer system configurations including hand-held devices, multiprocessor systems, microprocessor-based or programmable consumer electronics, minicomputers, mainframe computers and the like. The embodiment may also be practiced in distributed computing environments where tasks are performed by remote processing devices that are linked through a communications network. In a distributed computing environment, program modules may be located in both local and remote memory storage devices.

In addition, various programs and devices described hereinafter may be identified based upon the application for which they are implemented in a specific embodiment of the invention. However, it should be appreciated that any particular program or device nomenclature that follows is used merely for convenience, and the invention is not limited to use solely in any specific application identified and/or implied by such nomenclature.

Referring now to FIG. 1, a computer system 110 consistent with the invention is shown. For purposes of the invention, computer system 110 may represent any type of computer, computer system or other programmable electronic device, including a client computer, a server computer, a portable computer, an embedded controller, etc. The computer system 110 may be a standalone device or networked into a larger system. In one embodiment, the computer system 110 is an eServer iSeries 400 computer available from International Business Machines of Armonk, N.Y.

The computer system 110 could include a number of operators and peripheral systems as shown, for example, by a mass storage interface 137 operably connected to a direct access storage device 138, by a video interface 140 operably connected to a display 142, and by a network interface 144 operably connected to a plurality of networked devices 146. The display 142 may be any video output device for outputting a user interface. The networked devices 146 could be desktop or PC-based computers, workstations, network terminals, or other networked computer systems.

Computer system 110 is shown for a programming environment that includes at least one processor 112, which obtains instructions, or operation codes, (also known as opcodes) and data via a bus 114 from a main memory 116. The processor 112 could be any processor adapted to support the debugging methods, apparatus and article of manufacture of the invention. In particular, the computer processor 112 is selected to support monitoring of memory accesses according to user-issued commands. Illustratively, the processor is a PowerPC available from International Business Machines of Armonk, N.Y.

The main memory 116 could be one or a combination of memory devices, including Random Access Memory, nonvolatile or backup memory (e.g., programmable or Flash memories, read-only memories, etc.). In addition, memory 116 may be considered to include memory physically located elsewhere in a computer system 110, for example, any storage capacity used as virtual memory or stored on a mass storage device or on another computer coupled to the computer system 110 via bus 114.

The main memory 116 includes an operating system 118, a computer program 120 (to be debugged), and a programming environment 122 comprising a debugger program 123, Debug Information File 152, Control Flow Graph (CFG) 154, BranchSet 156, CDSet 158, Loop Nest Table 160, Loop Latch Table 162, ModBranchSet 164 and GlobalBranchSet 166. The programming environment 122 facilitates debugging the computer program 120, or computer code, by providing tools for locating, analyzing and correcting faults. One such tool is a debugger program 123 (also referred to herein as the debugger). In one embodiment, the debugger 123 is a VisualAge for C++ debugger modified according to the invention. VisualAge for C++ for OS/400 is available from International Business Machines of Armonk, N.Y. In a specific embodiment, the debugger 123 comprises a debugger user interface 124, expression evaluator 126, Dcode interpreter 128 (also referred to herein as the debug interpreter 128), debugger hook 134, a breakpoint manager 135 and a result buffer 136. Although treated herein as integral parts of the debugger 123, one or more of the foregoing components may exist separately in the computer system 110. Further, the debugger may include additional components not shown.

A debugging process is initiated by the debug user interface 124. The user interface 124 presents the program under debugging and highlights the current line of the program on which a stop or error occurs. The user interface 124 allows the user to set control points (e.g., breakpoints and watch points), display and change variable values, and activate other inventive features described herein by inputting the appropriate commands. In some instances, the user may define the commands by referring to high-order language (HOL) references such as line or statement numbers or software object references such as a program or module name, from which the physical memory address may be cross referenced.

The expression evaluator 126 parses the debugger command passed from the user interface 124 and uses a data structure (e.g., a table) generated by a compiler to map the line number in the debugger command to the physical memory address in memory 116. In addition, the expression evaluator 126 generates a Dcode program for the command. The Dcode program is machine executable language that emulates the commands. Some embodiments of the invention include Dcodes which, when executed, activate control features described in more detail below.

The Dcode generated by the expression evaluator 126 is executed by the Dcode interpreter 128. The interpreter 128 handles expressions and Dcode instructions to perform various debugging steps. Results from Dcode interpreter 128 are returned to the user interface 124 through the expression evaluator 126. In addition, the Dcode interpreter 128 passes on information to the debug hook 134, which takes steps described below.

After the commands are entered, the user provides an input that resumes execution of the program 120. During execution, control is returned to the debugger 123 via the debug hook 134. The debug hook 134 is a code segment that returns control to the appropriate user interface. In some implementations, execution of the program eventually results in an event causing a trap to fire (e.g., a breakpoint is encountered). Control is then returned to the debugger by the debug hook 134 and program execution is halted. The debug hook 134 then invokes the debug user interface 124 and may pass the results to the user interface 124. Alternatively, the results may be passed to the results buffer 136 to cache data for the user interface 124. In other embodiments, the user may input a command while the program is stopped causing the debugger to run a desired debugging routine. Result values are then provided to the user via the user interface 124.

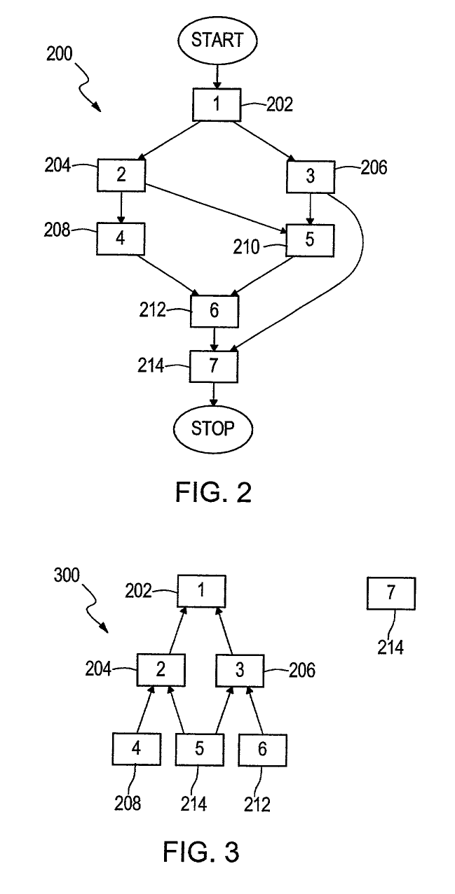

In some embodiments, the debugger 123 utilizes the Debug Information File 152 and CFG 154 to advantage. In particular, the Control Dependence Graph (CDG) 300, contained in the Debug Information File 152, and CFG 154 are used to trace program statement(s) that may have been executed prior to the halted program statement. In general, the CFG 154 contains a representation of blocks of executable computer program statements and the CDG 300 contains a representation of the blocks in the CFG 154 that are dependent on each other. The blocks are constructed during the compilation of computer program 120 by a compiler (not shown) known in the art. A basic block is a sequence of consecutive statements in which flow of control enters at the beginning and leaves at the end without halt or the possibility of branching except at the end. One illustration of the CFG 154 is shown in FIG. 2. Those skilled in the art will appreciate that even though FIG. 2 is described in terms of statically compiled and bound languages, these concepts can also be applied to dynamically bound languages such as Java without deviating from this invention. Additional information regarding compilers and related data structures may be found in Compilers: Principles, Techniques, and Tools; Alfred V. Aho, Ravi Sethi, Jeffery D. Ullman; Addison-Wesley Publishing Company 1986.

Referring again to FIG. 2, the CFG 154 illustrates program flow from one basic program block to another basic block. As shown, in some instances, a basic block may have more than one possible path. For example, Block 202 may branch to either Block 204 or Block 206 depending on the outcome of executing the conditional statement in Block 202. Also, Block 206 may branch to either Block 210 or Block 214. However, according to the example, program execution will always flow from Block 208 to Block 212 and from Block 212 to Block 214. Once the compiler constructs a CFG 154, a CDG can then be constructed.

FIG. 3 illustrates a CDG 300 for the basic blocks shown in FIG. 2. A CDG 300 is a common data structure used by optimizing compilers and was introduced in the paper The Program Dependence Graph and its Use in Optimization; Jeanne Ferrante, Karl J. Ottenstein, Joe D. Warren; ACM Transactions on Programming Languages and Systems; pages 319-349; Volume 9; Number 3; July 1987.

The CDG 300 is a tree structure built on top of the nodes representing basic blocks in a CFG 154. The CDG 300 represents which nodes are control dependent on other nodes in the CFG 154. The CDG 300 contains one block for each block in the corresponding CFG 154. As an illustration, there is an arc in the CDG 300 from Block 204 to Block 202 if and only if Block 202 ends in a conditional branch that can determine whether Block 204 will be executed. Block 204 is then said to be control dependent on Block 202. Conversely, we say that Block 202 controls execution of Block 204. In addition, Block 212 is control dependent on Block 206 because Block 206 controls whether the program will eventually flow to Block 212. In this example, Block 202 and Block 214 are not control dependent on any other blocks because the program will always flow to these blocks. Block 204 is dependent on Block 202 since the branch at the end of Block 202 can cause program flow to Block 206 or to Block 204. As illustrated, the CDG 300 only represents immediate control dependence arcs. For example, Block 208 is control dependent on Block 202 since if the branch in Block 202 is taken to Block 206, Block 208 will not be executed. This is implicit in the CDG 300 because of the two arcs from Block 208 to Block 204 and from Block 204 to Block 202.

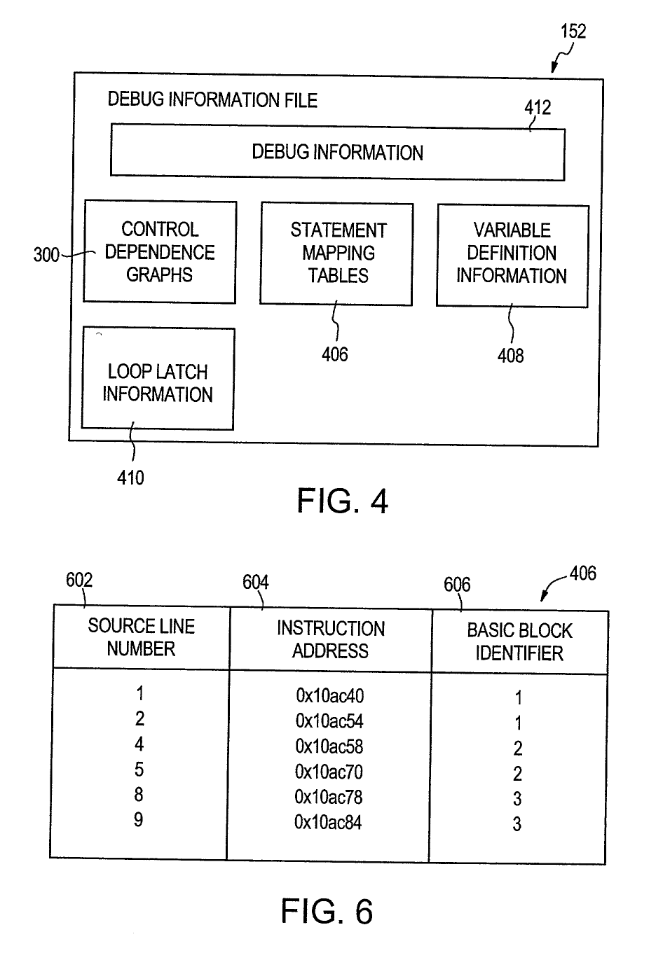

Also during compilation, the compiler constructs a Debug Information File. FIG. 4 illustrates one embodiment of a Debug Information File 152 shown in FIG. 1. The Debug Information File 152 is constructed during compilation of program 120 by a compiler known in the art and may comprise the Control Dependence Graph 300, Statement Mapping Table 406, variable definition information 408, loop latch information 410 and debug information 412 that conventionally consists of other program variable and statement information used in debugging a program. The Debug Information File 152 and its components will be discussed in detail below with respect to the embodiments.

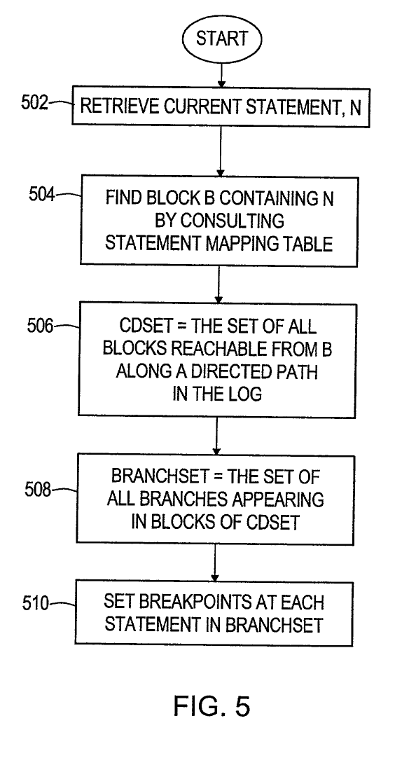

One embodiment illustrating a method of finding basic block branches of interest is shown as a method 500 in FIG. 5. Method 500 uses the Statement Mapping Table 406 to identify the basic block that contains the program statement number where the program stopped executing. One example of a Statement Mapping Table 406 is illustrated in FIG. 6. As illustrated, each source line number 602, denoting the program statement of the program being debugged, is referenced to an instruction address 604 locating the source line number in memory and a basic block identifier 606 identifying the basic block that contains the program statement. Referring back to FIG. 5, the method is entered at step 502 where the current statement number, or source line number 602, is retrieved. At step 504, the basic block identifier 606 for the current statement number (source line number 602) is retrieved from the Statement Mapping Table 406. At step 506 a set of all blocks contained in the CDG 300, on which the retrieved basic block identifier 606 is control dependent, is identified and stored in CDSet 158. That is, a set of all blocks reachable along a directed path in the CDG 300 from the block identified by the basic block identifier 606 retrieved at step 504 is stored in the Cdset 158. At step 508 the set of all branches contained in the basic blocks stored in the CDSet 158 is then stored in BranchSet 156. At step 510, a breakpoint is set at each branch stored in BranchSet 156.

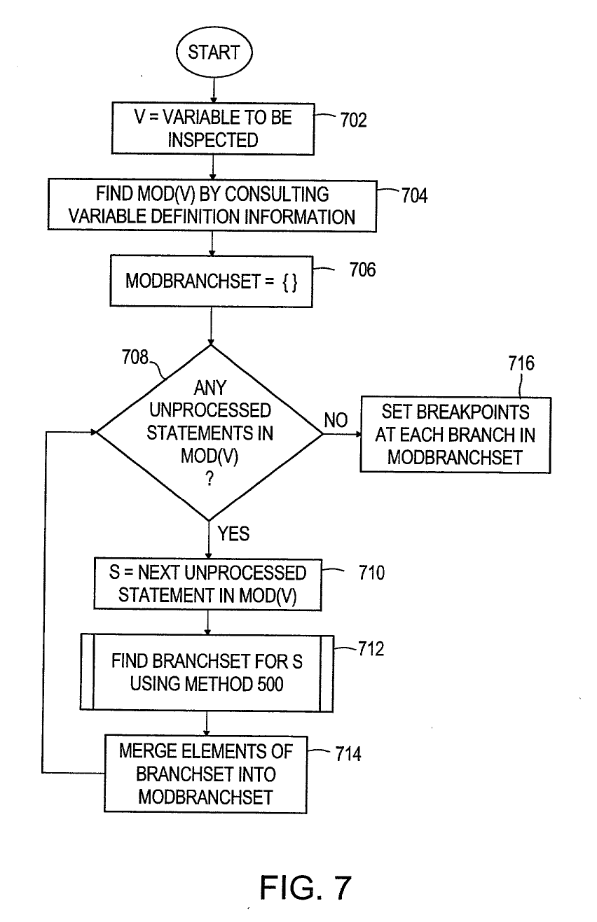

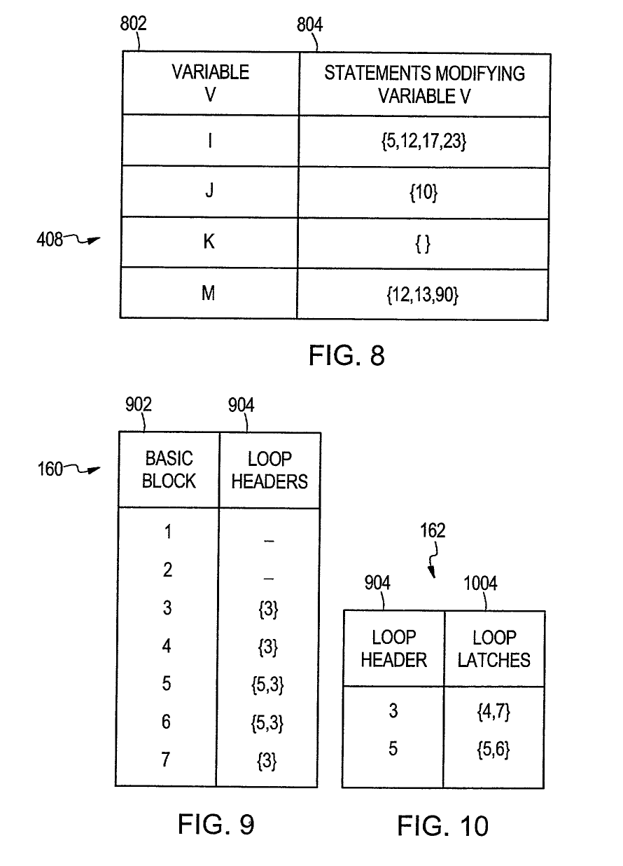

One embodiment illustrating a method of finding basic block branches that influence whether a particular variable of interest may be modified is shown as a method 700 in FIG. 7. For a particular variable, a set of statements modifying that variable is found by looking in the Variable Definition Information 408. One example of the Variable Definition Information 408 is illustrated in FIG. 8. As shown, the Variable Definition Information 408 comprises a plurality of records each defined by a variables column 802 and a statements column 804. Each entry of the statements column 804 contains one or more statements that modify the associated variable located in the variable column 802 of the same record. For each statement modifying variable 804, a BranchSet 154 is computed and stored in ModBranchSet 164. Referring back to FIG. 7, the method is entered at step 702 where the variable to be inspected is identified. At step 704, the statements modifying variable(s) contained in column 804 for the variable to be inspected (contained in the variable column 802) is found in the Variable Definition Information 408. At step 706, the storage area ModBranchSet 164 is initialized to an empty set. At step 708, the method 700 queries if there are any unprocessed statements contained in statements column 804. If so, the method proceeds to step 710 where the unprocessed statement is set to the variable “S”. At step 712, the method 700 invokes method 500 to find the BranchSet 154 for variable “S”. At step 714, the method stores the BranchSet 156 in ModBranchSet 164 and proceeds back to step 708. If at step 708, there are no unprocessed statements, the method 700 proceeds to, step 716 where breakpoints are set at every branch contained in ModBranchSet 164.

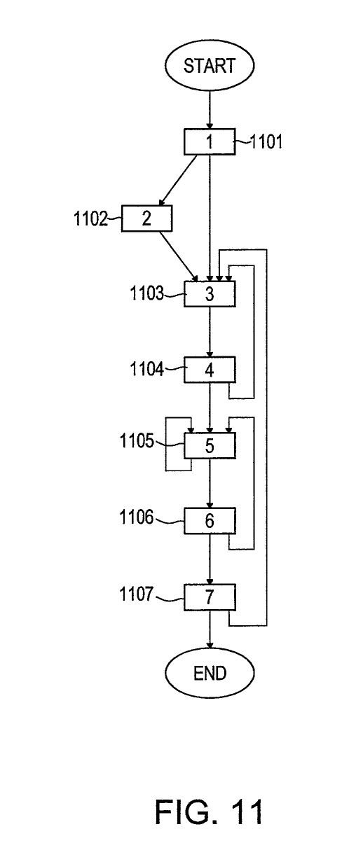

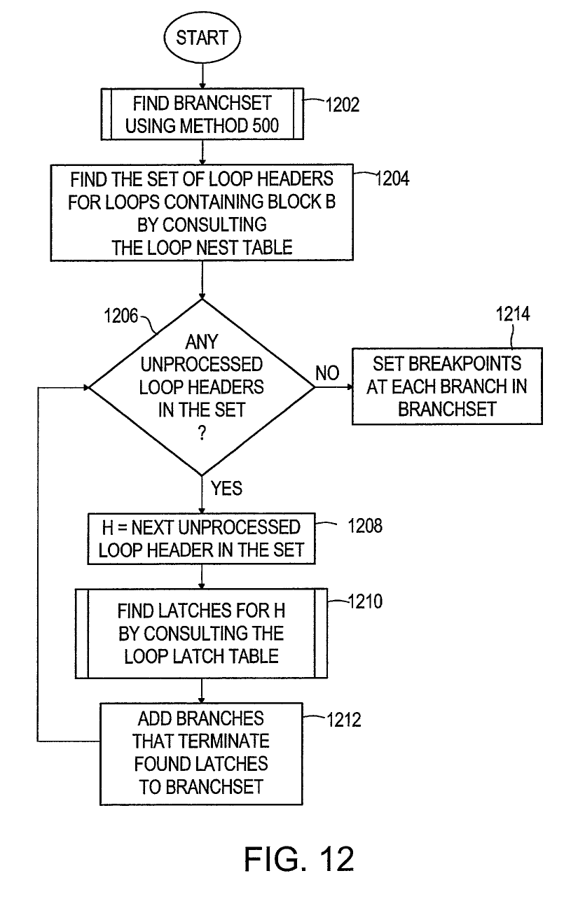

One embodiment illustrating a method of finding basic block branches of interest for blocks occurring in loops is shown as a method 1200 in FIG. 12. Method 500 shown in FIG. 5 identifies all branches that cause a statement to be executed for the first time. For statements appearing in loops, it is often interesting to also find those statements that can cause the loop to be repeated. Each basic block may be contained within one or more loops. A loop is a strongly connected region in a CFG. Each loop can be identified by a single entry block to the loop, called the loop header. A loop contains one or more loop latches, which are the block(s) that contain a conditional branch that tests to see if the loop should be repeated back to the loop header. FIG. 11 illustrates one example of a CFG comprising loop latches and loop headers. As shown, Block 1103 is a loop header for a loop comprising Blocks 1103, 1104, 1105, 1106 and 1107, with Block 1104 and Block 1107 as loop latches. For example, program execution will flow from Block 1101 and then to either Block 1102 or Block 1103. At Block 1103, the program will flow to Block 1104, the loop latch, and then possibly loop back to Block 1103, the loop header, until a condition is satisfied in the loop latch. When the condition in the loop latch is satisfied, program execution will flow from Block 1104 to Block 1105, and so on. Referring back to FIG. 12, method 1200 is entered at step 1202 where method 500 is invoked to find the BranchSet 156 for the current program statement. At step 1204, the method finds the set of loop headers for loops containing the basic block that contains the current statement by consulting the loop nest table 160. One example of a loop nest table 160 is illustrated in FIG. 9. Each row of the loop nest table 160 shows a basic block 902 and its associated loop headers 904. Referring back to FIG. 12, the method then queries if there are any unprocessed loop headers 904 in the set. If so, the method 1200 proceeds to step 1208 where the next unprocessed loop header 904 is set to the variable “H”. At step 1210, the method 1200 finds the loop latches 1004 for the unprocessed loop header 904 identified by the variable “H” by consulting the loop latch table 162. FIG. 10 illustrates one embodiment of a loop latch table 162 showing loop headers 904 correlated to loop latches 1004. Each row of the loop latch table 162 shows a loop header 904 and its associated loop latches 1004. Referring back to FIG. 12, at step 1212 the method 1200 stores branches that terminate loop latches 1004 in BranchSet 156. If at step 1206 there are no unprocessed loop headers 904, the method 1200 proceeds to step 1214 where breakpoints are set at each branch stored in BranchSet 156.

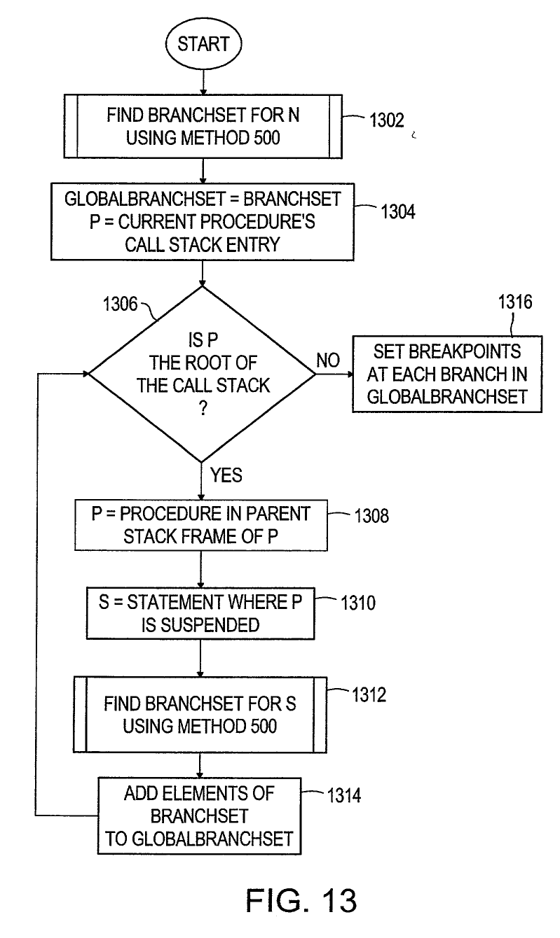

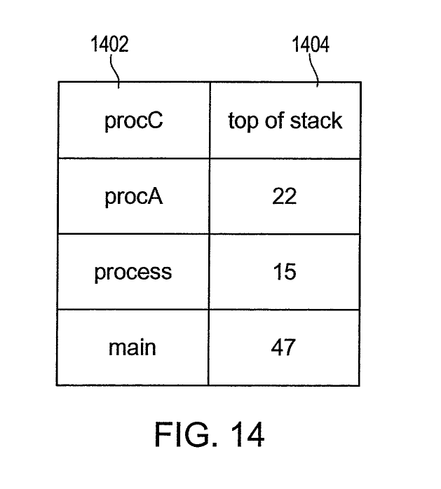

The foregoing embodiments all identify controlling branches only within the procedure containing the current statement. It is often useful to know about decision points outside the current procedure. One embodiment illustrating a method of finding basic block branches of interest using a call stack is shown as a method 1300 in FIG. 13. A call stack, known in the art, is a run-time representation of currently active routines in the running program being debugged. When the program first starts up, the main procedure of the running program is placed on the call stack as its first entry. If the main procedure calls another procedure, then an entry for that procedure is pushed onto the call stack. When a procedure returns, its call stack entry is popped, or removed from the stack. The call stack may contain saved registers, local variables, and the address, for example, to return to when a procedure ends processing, etc. A procedure, known in the art, is a portion of a computer program that performs a specific task and may be a subroutine or subprogram of the computer program being debugged. When a first procedure calls a second procedure, execution of the first procedure is suspended until the second procedure completes execution. The first procedure then resumes execution at the point where the first procedure suspended execution. FIG. 14 illustrates one embodiment of a call stack showing a procedure column 1402 correlated to the current statement number column 1404 where execution of the procedure 1402 was suspended when it called another procedure. Referring back to FIG. 13, the method is entered at step 1302 where method 500 is invoked to find the BranchSet 156 for the current statement. At step 1304, the method stores the BranchSet 156 in GlobalBranchSet 166 and sets the variable “P” to point to the top (current) entry of the call stack. The method 1300 then queries at step 1306 if the BranchSet 156 identified by the variable “P” is the root of the call stack 1400. The root of the call stack 1400 is the procedure that is pushed to the bottom of the stack. If it is not the root then the method 1300 proceeds to step 1308 where the procedure in the parent stack frame (calling procedure) is set to the variable “P”. At step 1310, the statement where the procedure identified by the variable “P” was suspended is set to the variable “S”. At step 1312 method 500 finds the BranchSet 154 for “S”. At step 1314, the elements of BranchSet 154 are stored in GlobalBranchSet 166. If at step 1306, “P” is the root of the call stack 1400, the method 1300 then proceeds to step 1316 where a breakpoint is set at each branch stored in GlobalBranchSet 166.

While the foregoing is directed to embodiments of the present invention, other and further embodiments of the invention may be devised without departing from the basic scope thereof, and the scope thereof is determined by the claims that follow.

What is claimed is:

1. A method for inserting breakpoints in a program being debugged, comprising:
identifying a statement for the program being debugged;
determining which basic block contains the statement;
determining which blocks control execution of the basic block; and
inserting a breakpoint at each branch contained in the blocks controlling execution of the basic block.

2. The method of claim 1, wherein the statement is the location where the program being debugged halted execution.

3. The method of claim 1, wherein the blocks controlling execution of the basic block are blocks on which the basic block is control dependent.

4. The method of claim 1, wherein identifying the statement comprises identifying a statement that may modify a program variable.

5. The method of claim 4, wherein identifying the statement that may modify a program variable comprises accessing a table comprising the variable mapped to statements that may modify the variable.

6. The method of claim 1, wherein identifying the statement comprises identifying statements associated with loop latches.

7. The method of claim 6, wherein identifying statements associated with loop latches comprises accessing tables comprising the basic block mapped to the loop latches.

8. The method of claim 1, wherein identifying the statement comprises identifying a currently executing statement of each of a plurality of subprograms.

9. The method of claim 8, wherein each of the plurality of subprograms is a portion of the program being debugged and performs a specific task.

10. The method of claim 8, wherein identifying the currently executing statement comprises accessing a table comprising the plurality of subprograms mapped to its respective currently executing statement.

11. The method of claim 8, wherein the blocks controlling execution of the basic block are blocks on which the basic block is control dependent.

12. A computer system comprising at least one processor configured to execute a debugging program, wherein the processor, when executing the debugging program, is configured to perform an operation comprising:
identifying a statement for the program being debugged;
determining which basic block contains the statement;
determining which blocks control execution of the basic block; and
inserting a breakpoint at each branch contained in the blocks controlling execution of the basic block.

13. The computer system of claim 12, wherein identifying the statement comprises:
identifying a program variable; and
determining which statements may modify the variable.

14. The computer system of claim 12, wherein identifying the statement comprises:
determining a plurality of sets of loop latches for the basic block; and
identifying the statements associated with loop latches.

15. The computer system of claim 12, wherein identifying the statement comprises:
identifying a currently executing statement of a plurality of subprograms.

16. A signal bearing medium, comprising a program which, when executed by a processor, performs an operation, comprising:
identifying a statement for the program being debugged;
determining which basic block contains the statement;
determining which blocks control execution of the basic block; and
inserting a breakpoint at each branch contained in the blocks controlling execution of the basic block.

17. The signal bearing medium of claim 16, wherein the statement is the location where the program being debugged halted execution.

18. The signal bearing medium of claim 16, wherein the blocks controlling execution of the basic block are blocks on which the basic block is control dependent.

19. The signal bearing medium of claim 16, wherein identifying the statement comprises identifying a statement that may modify a program variable.

20. The signal bearing medium of claim 19, wherein identifying the statement that may modify a program variable comprises accessing a table comprising the variable mapped to statements that may modify the variable.

21. The signal bearing medium of claim 16, wherein identifying the statement comprises identifying statements associated with loop latches.

22. The signal bearing medium of claim 21, wherein identifying statements associated with loop latches comprises accessing tables comprising the basic block mapped to the loop latches.

23. The signal bearing medium of claim 16, wherein identifying the statement comprises identifying a currently executing statement of each of a plurality of subprograms.

24. The signal bearing medium of claim 23, wherein each of the plurality of subprograms is a portion of the program being debugged and performs a specific task.

25. The signal bearing medium of claim 23, wherein identifying the currently executing statement comprises accessing a table comprising the plurality of subprograms mapped to its respective currently executing statement.

26. The signal bearing medium of claim 23, wherein the blocks controlling execution of the basic block are blocks on which the basic block is control dependent.
